(19) United States
(12) Patent Application Publication
(10) Pub. No.: US 2019/0102822 A1
(43) Pub. Date: Apr. 4, 2019

(54) System and method for fulfilling product orders

(71) Applicant: Intelligent Malt, LLC, Fargo, ND (US)

(72) Inventors: David Batcheller, Fargo, ND (US); Chris Anderson, Moorhead, MN (US)

(21) Appl. No.: 16/114,705

(22) Filed: Aug. 28, 2018

Related U.S. Application Data
(60) Provisional application No. 62/551,401, filed on Aug. 29, 2017.

(51) Int. Cl. G06Q 30/06; G06Q 10/08

(52) U.S. Cl. CPC G06Q 30/0635; G06Q 10/083

(57) ABSTRACT

Methods and systems for fulfilling a product order. The systems and methods described herein may receive a product order and then assess the ability of one or more pieces of machinery at one or more malt houses to fulfill at least a portion of the product order. Based on the ability of at least one standardized piece of machinery, each piece of machinery being associated with a malt house, the systems and methods may assign at least a portion of the product order to a piece of machinery for fulfillment.

### CROSS-REFERENCE TO RELATED APPLICATIONS

The present application claims benefit of co-pending U.S. provisional application No. 62/551,401, filed on Aug. 29, 2017, the entire disclosure of which is incorporated by reference as if set forth in its entirety herein.

### TECHNICAL FIELD

Embodiments described herein generally relate to systems and methods for fulfilling a product order and, more particularly but not exclusively, to systems and methods for fulling a beverage product order.

### BACKGROUND

Existing malting facilities generally operate with similar supply chains. For example, existing supply chains generally have three separate sections or phases. First, a farmer grows raw ingredients that are purchased by a malt house. The malt house may then malt a desired product and send it to a customer. The customer may be a craft brewer, a distributor, a warehouse, or other storage facility that stores the product until it is purchased.

An issue with this setup or workflow, however, is that it lacks communication among all involved parties. For example, the brewer generally communicates with the maltster, the maltster generally communicates with the farmer, but there is little communication (if any) between the brewer and the farmer.

Another issue with these existing techniques or workflows is that many brewers are unable to accurately replicate a recipe after switching suppliers. Problems arise when a brewer first uses a small malt house to create a niche recipe. If the recipe becomes popular, the small malt house may have difficulty in scaling and keeping up with increased production demands.

A brewer may need to rely instead on a larger malt house with more capacity. However, nearly every malt house and the machines therein are different, and the larger malt house may be unable to accurately replicate the first malt house's product due to inconsistencies in machinery and malt house customs. In other words, it is nearly impossible for a brewer to simply transfer their work instructions to a larger malt house and obtain exactly the same product as they would from the smaller malt house.

A need exists, therefore, for methods and systems for fulfilling orders that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for fulfilling a product order. The method includes receiving, at a network interface, a product order from a brewer; assessing, using a processor executing instructions stored on a memory, an ability of at least one standardized piece of machinery, each piece of machinery being associated with a malt house, to fulfill at least a portion of the product order; and assigning, using the processor, at least a portion of the product order to a first piece of machinery at a first malt house for fulfillment based on the ability of the first piece of machinery to fulfill at least the portion of the order.

In some embodiments, the ability of the at least one standardized piece of machinery depends on at least one of ingredients available, capacity, and delivery ability at the malt house associated with the at least one piece of machinery.

In some embodiments, receiving the product order from the brewer includes receiving a product specification including at least one of product ingredients, product quantity, a product recipe, product delivery location, and product delivery time.

In some embodiments, the method further includes presenting a questionnaire to the brewer to prompt the brewer to provide the product order.

In some embodiments, the method further includes reassigning at least the portion of the order from the first piece of machinery at the first malt house to a second piece of machinery at the first malt house.

In some embodiments, the method further includes reassigning at least the portion of the order from the first piece of machinery at the first malt house to a second piece of machinery at a second malt house.

In some embodiments, the method further includes proposing an offer for fulfillment of at least the portion of the order to at least one malt house; and receiving an acceptance of the offer from the at least one malt house or a declination of the offer from the at least one malt house.

In some embodiments, the method further includes adding the brewer and the malt house to a list of authorized entities stored in a database.

According to another aspect, embodiments relate to a system for fulfilling a product order. The system includes a network interface for receiving a product order from a brewer; and a processor executing instructions stored on a memory and configured to assess an ability of at least one standardized piece of machinery, each piece of machinery being associated with a malt house, to fulfill at least a portion of the product order; and assign at least a portion of the product order to a first piece of machinery at a first malt house for fulfillment based on the ability of the first piece of machinery to fulfill at least the portion of the order.

In some embodiments, the ability of the at least one standardized piece of machinery depends on at least one of ingredients available, capacity, and delivery ability at the malt house associated with the at least one piece of machinery.

In some embodiments, the product order includes a product specification including at least one of product ingredients, product quantity, a product recipe, product delivery location, and product delivery time.

In some embodiments, the processor is further configured to present, using a user interface, a questionnaire to the brewer to prompt the brewer to provide the product order.

In some embodiments, the processor is further configured to reassign at least the portion of the order from the first piece of machinery at the first malt house to a second piece of machinery at the first malt house.

In some embodiments, the processor is further configured to reassign at least the portion of the order from the first piece of machinery at the first malt house to a second piece of machinery at a second malt house.

In some embodiments, the processor is further configured to propose an offer for fulfillment of at least the portion of the order to at least one malt house; and receive an acceptance of the offer from the at least one malt house or a declination of the offer from the at least one malt house.

In some embodiments, the processor is further configured to add the brewer and the malt house to a database including a list of authorized entities.

In some embodiments, an identity of the brewer is unknown to the malt house.

In some embodiments, an identity of the malt house that fulfills at least the portion of the order is unknown to the brewer.

### BRIEF DESCRIPTION OF DRAWINGS

Non-limiting and non-exhaustive embodiments of the embodiments herein are described with reference to the following figures, wherein like reference numerals refer to like parts throughout the various views unless otherwise specified:

FIG. 1 illustrates a prior art workflow for fulfilling product orders;

FIG. 2 illustrates an existing E-commerce workflow for buying and selling goods involving the parties of FIG. 1;

FIG. 3 illustrates a system for fulfilling a product order in accordance with one embodiment;

FIG. 4 depicts a flowchart of a method for signing a malt house onto a network of entities in accordance with one embodiment;

FIG. 5 depicts a flowchart of a method for exchanging data between the system of FIG. 3 and contracted entities in accordance with one embodiment;

FIG. 6 depicts a flowchart of a method depicting the chain of events involving a maltster purchasing ingredients in accordance with one embodiment;

FIG. 7 depicts a flowchart of an E-commerce workflow used by the system of FIG. 3 in accordance with one embodiment; and

FIG. 8 depicts a flowchart of a method for fulfilling a product order in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

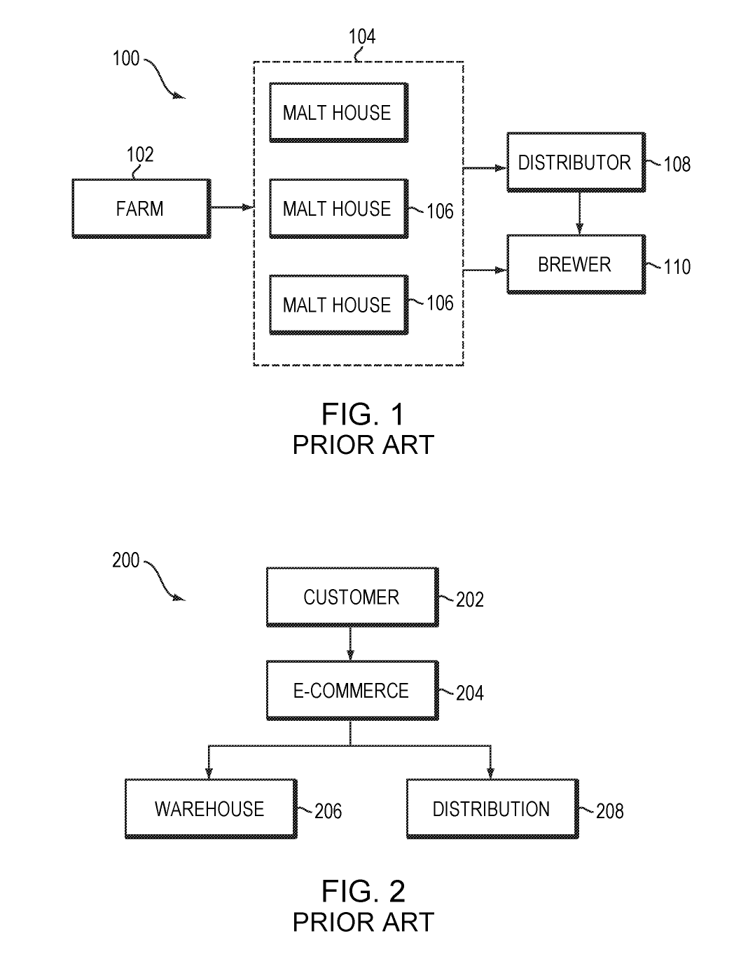

As discussed previously, existing workflows involving farmers, brewers, maltsters, distributors, etc., generally do not permit or otherwise involve communication between all parties. For example, FIG. 1 illustrates a prior art workflow 100 involving a farmer 102, a collection 104 of malt houses 106, a distributor 108, and a brewer 110.

A malt house is a facility in which malt is produced and/or stored. In the traditional supply chain, malt houses are separate entities from the farmer and act as a go-between for the farmer and the brewer.

As seen in FIG. 1, the workflow 100 involves four separate parties. As discussed previously, a farmer 102 grows ingredients that are purchased by one or more malt houses 106.

After purchasing the ingredients, a malt house 106 will malt the product and either send to it a distributor 108 or to a customer such as a brewer 110. This workflow 100, however, lacks communication between all parties. For example, and as seen in FIG. 1, the brewer 110 may communicate with a malt house 106, the malt house 106 may communicate with the farmer 102, but there is little to no communication between the brewer 110 and the farmer 102.

As another example, FIG. 2 illustrates an existing E-commerce workflow 200 for buying and selling goods involving the parties of FIG. 1. The workflow 200 may begin with a customer 202 going online to a website to purchase goods. An E-commerce platform 204 may sell goods in one of two ways. The E-commerce platform 204 may either sell the goods from a product warehouse 206 owned by the platform 204, or the E-commerce platform 204 may function as a storefront for another company and as a distributor for distribution tasks 208. Put another way, an operator of the E-commerce platform 204 may sell the product through their website, but they may not own the warehouse that supplies the product.

Embodiments described herein relate to a distribution network that connects and oversees farmers, maltsters, and brewers to more efficiently and accurately fulfill product orders. To accomplish these objectives, the systems and methods described herein may have a network of maltsters that use standardized equipment or machinery (for simplicity, “machinery”) to service work instructions communicated to malt houses in the network. This creates consistency among the malting community and allows jobs to be sourced to other facilities when the demand for a particular product is high.

More specifically, the systems and methods of various embodiments described herein provide an ecosystem that replaces the above-discussed step-by-step supply chain method with a more fluid system. The systems described herein oversee or otherwise broker many relationships to help foster an active malting community.

In accordance with the systems and methods described herein, the farmer and the malt house may be combined into one entity to create a more direct link between the agricultural product and the finished malt product. The Applicant has created a platform that, in the event a participating farmer owns a malt house, enables a brewer to communicate directly with the farmer.

This platform may function as a business hub for all participating brewers, maltsters, farmers, etc. Additionally, the supply chain enabled by the systems and methods described herein allows a customer to contact a farmer directly (who may have their own malt house) to obtain malted grains or other type of commodity directly from the farmer.

The malt houses that are in communication with the systems described herein or have otherwise joined the network of connected entities will use standardized pieces of machinery. This removes irregularities in, for example, tank size, machine settings, or the like and enables consistent production across one or more malt houses.

As mentioned previously, a brewer may rely on a particular malt house for a certain product that is crucial to an overall recipe. Problems may arise when that particular malt house is out of a particular ingredient that is crucial to a recipe and/or unable to produce it for the brewer because they are at capacity, a machine is out of order, or the like.

Accordingly, the systems and methods overcome these disadvantages of existing supply chains by essentially creating dozens or hundreds of the same malt house. This means that if one malt house (or a piece of machinery within a malt house) is operating at capacity or out of ingredients, the systems and methods described herein can direct the same work instructions to another machine at the same or a different malt house. It can then produce the same product that would have been expected from the original malt house.

Once the product is complete the malt house may send the product to a distribution warehouse for inspection and further shipment. The distribution warehouse may allow for anonymity between the customers and the malt house(s). For inspection, the malt house may submit a portion of a completed batch of the product to the distribution warehouse for a laboratory analysis. Following a positive analysis, the malt house may receive a certificate of analysis showing that the batch is satisfactory.

The systems and methods described herein may also facilitate the pickup and delivery of the final product through various shipping options selected by the customer. The customer may also receive tracking information once the product is shipped.

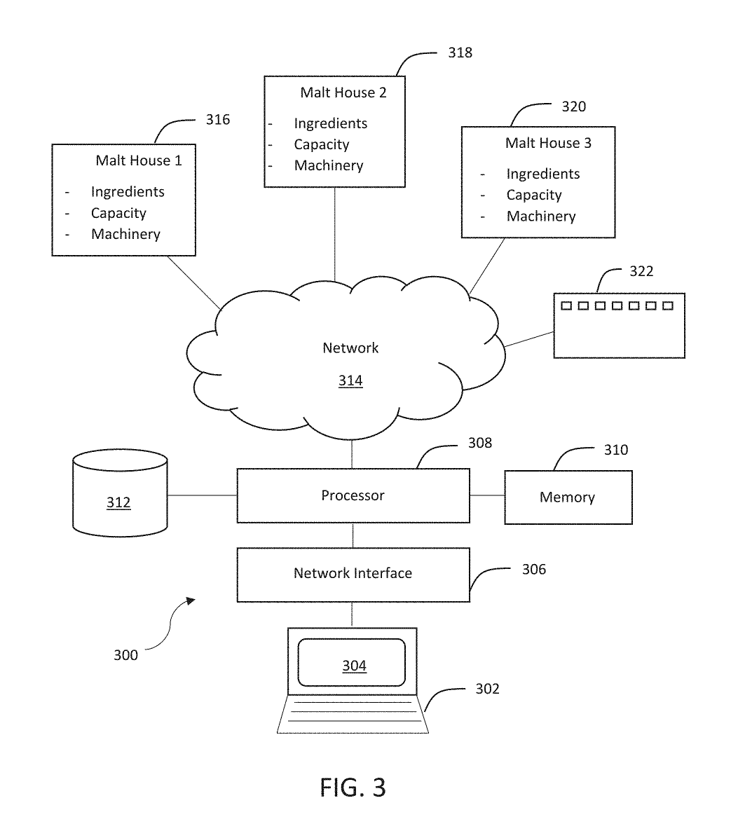

FIG. 3 illustrates a system 300 for fulfilling a product order in accordance with one embodiment. The system 300 of FIG. 3 may include a user device 302 executing a user interface 304, a network interface 306, a processor 308 executing instructions stored on a memory 310, wherein the processor is in communication with a database 312 and one or more networks 314. The components of the system 300 may be in further communication with one or more malt houses 316, 318, 320 and a distribution warehouse 322 (or some other distribution location).

The user device 302 may be any suitable device configured to execute the user interface 304. The user device 302 may be configured as, for example, a smartphone, a PC, laptop, tablet, smartwatch, or the like. The exact configuration of the user device 302 may vary as long as it can execute and present the user interface 304 to accomplish the various features described herein.

The user interface 304 may enable a user such as a brewer to place a product order and input various parameters or specifications related to the ordered product. These may include desired amounts of the product, ingredients, recipes, instructions, delivery locations, delivery times, or the like.

The network interface 306 may receive data such as product orders from one or more user devices 302 and pass the received data to the processor 308. The network interface 306 may further communicate data to the user device 302 such as data regarding the status of any orders.

The processor 308 may be any hardware device capable of executing instructions stored on memory 310 to accomplish the features described herein. The processor 308 may be a microprocessor, a field programmable gate array (FPGA), an application-specific integrated circuit (ASIC), or other similar device.

In some embodiments, such as those relying on one or more ASICs, the functionality described as being provided in part via software may instead be configured into the design of the ASICs and, as such, the associated software may be omitted. The processor 308 may be configured as part of the user device 302 on which the user interface 304 executes, such as a laptop, or may be located at some remote location.

The memory 310 may be L1, L2, L3 cache or RAM memory configurations. The memory 310 may include non-volatile memory such as flash memory, EPROM, EEPROM, ROM, and PROM, or volatile memory such as static or dynamic RAM, as discussed above. The exact configuration/type of memory 310 may of course vary as long as instructions for fulfilling a product order can be executed by the processor 308 to accomplish the features of various embodiments described herein.

The database 312 may store various types of data to accomplish the features of the embodiments described herein. For example, the database 312 may store data regarding registered entities (e.g., malt houses and brewers that have joined the network), recipes, data regarding ingredients, or the like.

The network(s) 314 may link the various devices and entities with various types of network connections. The network(s) 314 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 314 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

There may be one or more malt houses 316, 318, and 320 that are part of or otherwise in communication with the system 300. Each malt house may communicate data regarding operations therein such as the ingredients the malt house has available, the capacity/availability of the malt house to take on new jobs, data regarding pieces of machinery at the malt house, etc. The system 300 may also include one or more distribution warehouses 322 for storing completed products and for performing any required testing or inspections.

The malt houses in communication with the system 300 may each include one or more standardized pieces of machinery. This creates consistency within a malt house and across multiple malt houses so that a brewer's product can be replicated across multiple pieces of machinery at one or more malt houses. These standardized pieces of machinery may accept product orders or at least a portion of a product order from the processor 308 if they have the capacity and ingredients available to fulfill the order.

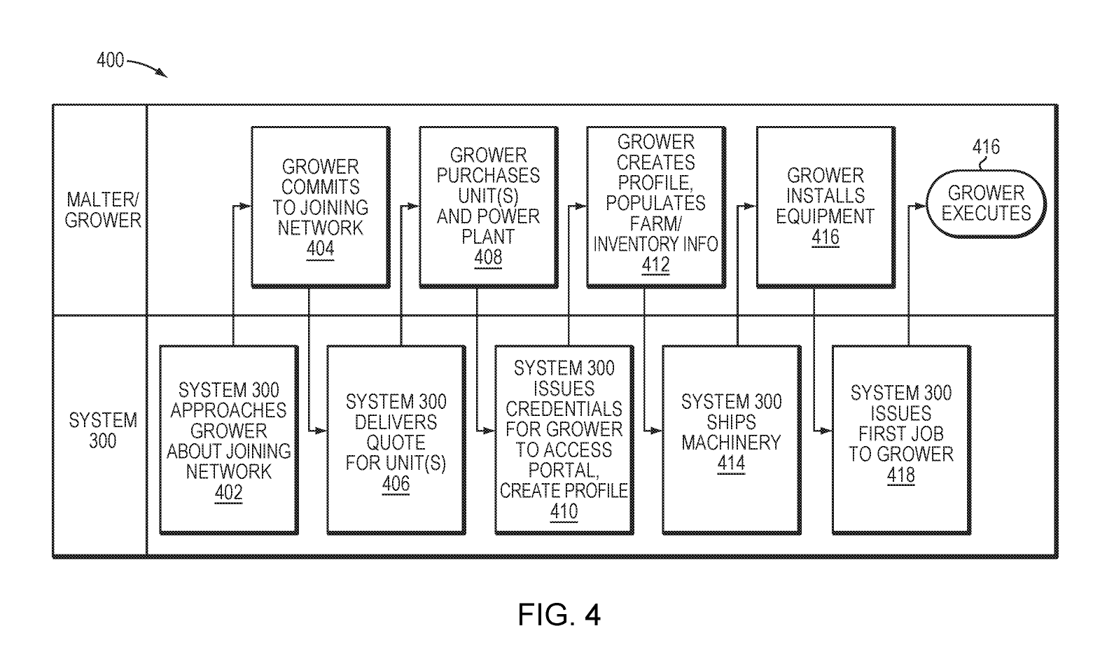

FIG. 4 depicts a flowchart of a method 400 for signing a malt house onto a network of entities to participate in the disclosed systems and methods for fulfilling product orders. A maltster or farmer (for simplicity, “grower”) may agree to join the network for various reasons such as to add value to an agricultural commodity as a source of income.

Method 400 begins with step 402 in which the system 300 approaches a grower about joining the network. For example, a particular operator may input a list of prospective growers into an interface so that the system 300 emails or messages the growers to invite them to the network.

If the grower is interested, they may join the network in step 404. The grower may, for example, respond to an email or click a URL on a grower interface to join the network. If the grower is not interested in joining the network, they may simply disregard the invitation.

Step 406 involves the system 300 quoting prices for machinery used by growers in the network. For example, the system 300 may store data regarding various standardized pieces of machinery (e.g., model numbers, prices) that are used by the growers in the network.

If the prices and terms are agreeable to the grower, the grower may agree to purchase the unit(s) as well as other types of machinery (e.g., a power plant) in step 408. If the terms or prices are not agreeable to the recently-joined grower, the grower may simply decline to purchase machinery or other types of equipment.

Step 410 involves the system 300 providing credentials to the grower and access to a portal to allow the grower to create a grower profile. The grower may create a username, password(s), and input any appropriate parameters about themselves in step 412. For example, the grower may input or otherwise provide inventory information such as the ingredients they have available.

In step 414, the system 300 may ship standardized pieces of machinery to the recently-joined grower. The type of machinery or equipment shipped may vary depending on the exact type of work that the grower will undertake. However, the type of equipment shipped to each maltster will be the same for maltsters that are engaged in the same type work. In other words, maltsters that join the network will have standardized machinery so that recipes and products can be replicated across different maltsters.

The recently-joined grower may install the equipment in step 416. Once installed, the system 300 may issue a job to the grower in step 418. The malt house may accept or decline any job that the system 300 offers. The grower may then execute the job in step 416. The job may involve following a recipe to create some product and then sending the final product to the distribution warehouse 322 or to the customer.

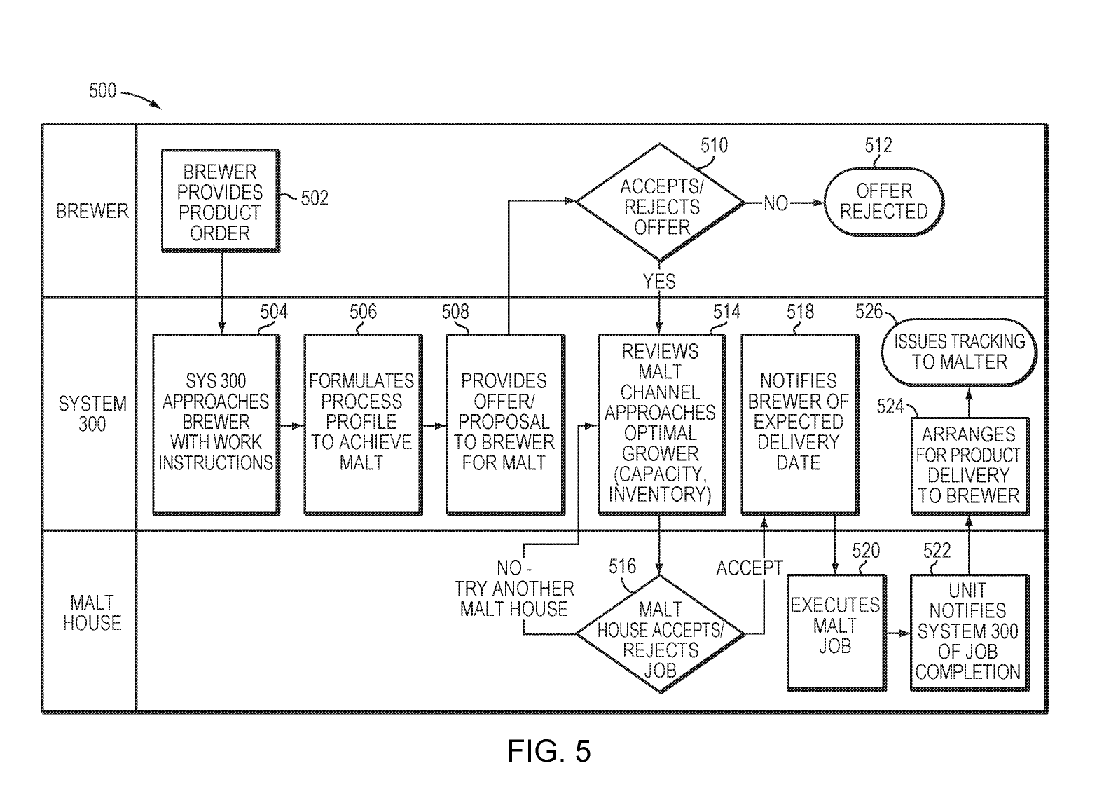

FIG. 5 depicts a flowchart of a method 500 for exchanging data between the system 300 and contracted parties. As mentioned previously, the customer is often a craft brewer looking to create a custom recipe. Accordingly, the method 500 may begin with step 502 in which a brewer provides a product order. The brewer may use a user interface such as the user interface 304 of FIG. 3 to input specifications such as ingredients to use, amounts of ingredients to use, a desired amount of the product, grower region(s), recipes, delivery date(s), delivery location(s) or other types of specifications for the desired product. By allowing the brewer to input parameters to request a product with unique characteristics such as a specific grain or flavor profile, the system 300 also makes it more difficult for competitors to try to emulate the product.

In step 504, the system 300 may respond to or otherwise approach the brewer with a set of work instructions to implement the brewer's product order for the brewer's approval. In step 506 the system 300 may formulate a process profile to achieve the specifications desired by the brewer. The system 300 may provide the formulated process profile to the brewer in step 508. The brewer may then either accept or reject the offer in step 510. For example, step 512 of method 500 shows the brewer declining the offer.

Alternatively, the brewer may accept the offer. The system 300 may then analyze one or more growers to find an optimal entity to fulfill at least a portion of the brewer's order. The ability of a grower to fulfill at least a portion of an order may be based on their available ingredients, inventory, capacity, etc. The system 300 may then propose an offer to a particular grower to fulfil at least a portion of the brewer's order in step 514. In other words, the system finds one or more available malt houses and pieces of machinery within the malt house(s) that have the capacity and ingredients to produce the product.

The grower may either accept or decline the job in step 516. If the malt house declines the job, the system 300 may search to find another malt house or malt houses to fulfill at least a portion of the order.

On the other hand, a grower may accept the job to fulfill at least a portion of the order. Then, in step 518, the system 300 may notify the brewer of the expected delivery date of their product.

The grower may then execute the job to fulfill at least the portion of their assigned order in step 520. For example, the job may be assigned to one or more particular pieces of machinery within the malt house.

Once completed, the grower may notify the system 300 that the job has been completed in step 522. The system 300 may then arrange for the product to be delivered to the brewer in step 524. As part of the delivery, the system 300 may also issue tracking information to the grower and/or the brewer in step 526 to allow them to track the delivery. The finished product may also be delivered to the distribution warehouse 322 for a quality check or inspection before being delivered to the customer.

Accordingly, the grower essentially uses the system 300 as a brokerage service to sell malt. The system 300 allows growers to maximize the return of their assets that are used to produce commodities on the farm.

Method 500 also offers both the customer and the supplier a certain level of privacy. The system 300 is transparent with respect to the options regarding the raw input, such as by identifying the area in which the product is grown, but the malt house will not know for whom they are making the malt. Similarly, the brewer will not know the specific malt house making their product. Certain details with respect to the product such as the type of raw ingredients will be available to the two entities, but the identity of the two entities will not be known to one another.

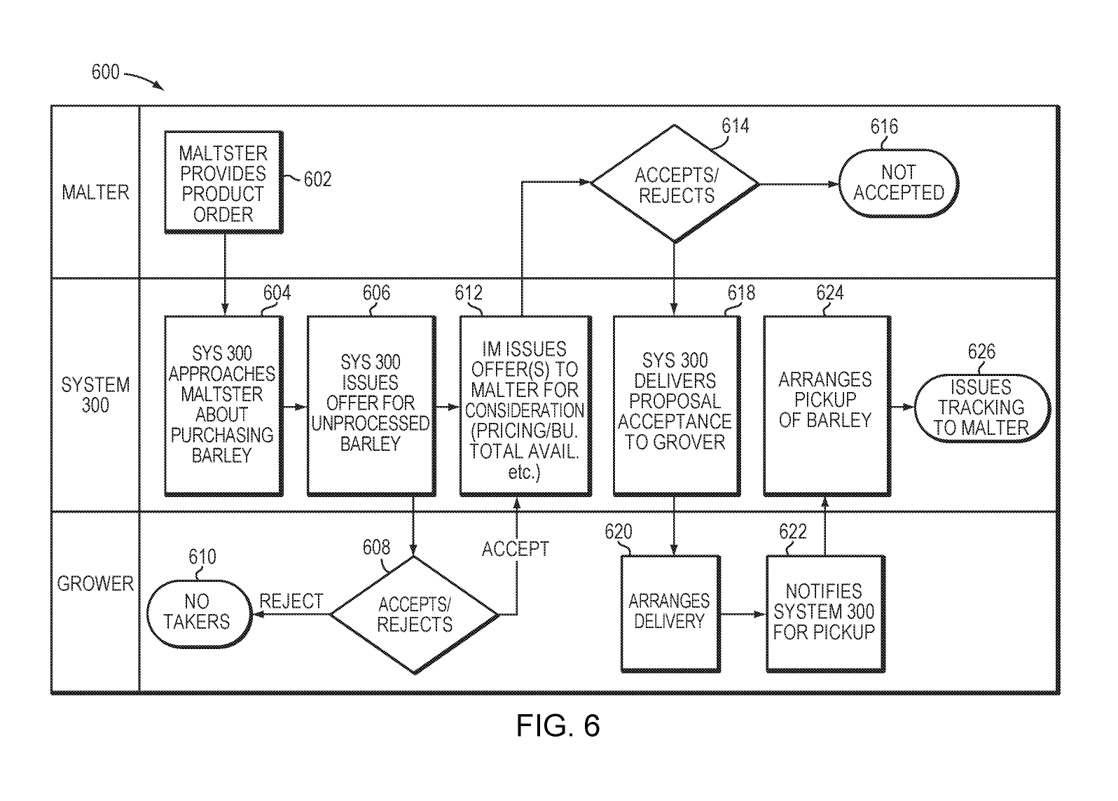

FIG. 6 depicts a flowchart of a method 600 that depicts the chain of events if the maltster has a malt house that is not located on a farm, but nonetheless needs to purchase ingredients. In this scenario, the brewer may be interested in purchasing barley from a farmer, specifically in areas in which barley is seldom grown. In these cases the systems and methods described herein may connect the maltster and the farmer to enable this transaction.

Method 600 begins with step 602 in which a maltster contacts the system 300 seeking specific ingredients. In step 604, the system 300 may respond to or otherwise approach the maltster about purchasing ingredients such as barley.

Step 606 involves the system 300 issuing offers for unprocessed barley. In step 608, growers may either decline the offer (step 610) or accept the offer. If a grower accepts the offer, the system 300 may then relay one or more offers to the maltster for their consideration (e.g., pricing/bu, availability, etc.) in step 612. In step 614, the maltster may decide whether to reject the offer (step 616) or accept the offer by the system 300.

If the maltster accepts the offer, the system 300 may deliver the proposed acceptance to the grower in step 618. The grower may then arrange for delivery of the barley in step 620. Once ready for delivery, the grower may message the system 300 and/or distribution warehouse in step 622. The system 300 may then arrange for pickup of the barley in step 624 and issue tracking information to the maltster in step 626.

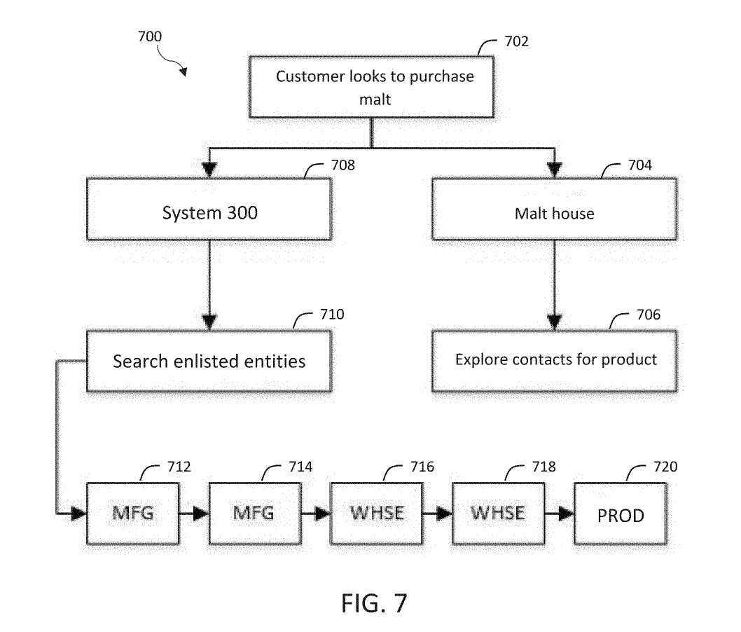

FIG. 7 depicts an E-commerce workflow 700 used by the system 300 in accordance with one embodiment. The workflow 700 begins with a customer looking to purchase malt in step 702. One option is for the customer to purchase malt through a particular malt house in step 704, similar to a brick and mortar store. This is generally not too common, but may occur if the customer has a good relationship with a specific malt house. If the malt house does not have the product, the malt house may reach out to other maltsters or warehouses in step 706 to deliver the product in an effort to maintain the relationship with the customer.

Another option for the customer is to use the system 300 in step 708. As discussed above, the customer may use a portal to access the system 300. The system 300 may, as discussed above, search through enlisted malt houses (and specific pieces of machinery) in step 710 that are in the network (e.g., stored in the database 312 of FIG. 3) and review the utilization and/or availability of each malt house to create the product.

From there, the system 300 may decide whether the product needs to come from a specific malt house utilizing the standardized malting machinery associated with the system 300 or from one of the system's 300 warehouses. Accordingly, the system 300 may analyze one or more growers 712, 714 (e.g., malt houses) and one or more warehouses 716, 718, to deliver the end product in step 720.

Accordingly, the portal accessible by a customer interfaces with the system 300, which in turn communicates with each piece of machinery so that the system 300 can deliver orders or products to the correct outlet. Another advantage of this connectivity is that the system 300 can check the capacity of any malt house (and each individual piece of machinery therein) at any time. This gives maltsters an opportunity to keep their facilities operating at maximum capacity as much as possible while delivering a consistent product to customers.

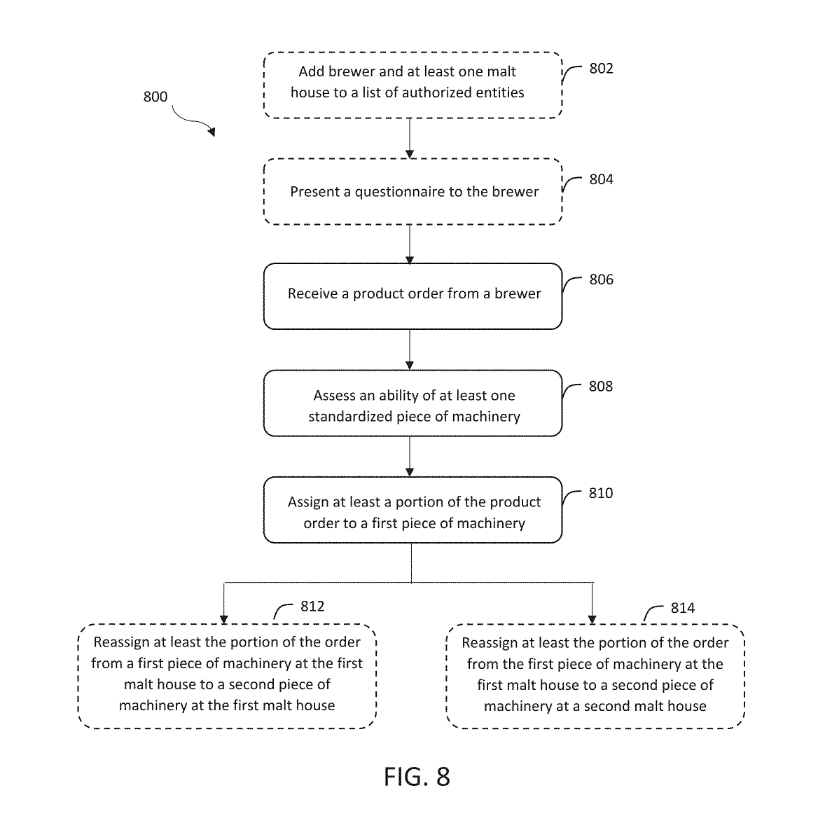

FIG. 8 depicts a flowchart of a method 800 for fulling a product order in accordance with one embodiment. Step 802 is optional and involves adding a brewer and at least one malt house to a list of authorized entities stored in a database. This step helps keep track of which particular brewers and malt houses have registered with or have otherwise joined the network so that they are permitted to place and execute orders, respectively.

Step 804 is optional and involves presenting a questionnaire to the brewer to prompt the brewer to provide a product order. This questionnaire may prompt the brewer to, for example, input specific ingredients, instructions, or the like. The questionnaire may be communicated to a user device such as the user device 302 of FIG. 3 for presentation to the brewer.

Step 806 involves receiving, at a network interface, a product order from a brewer. The product order may be in the form of the questionnaire of step 804, for example. The product order may essentially be a set of work instructions that define the brewer's desired product. The work instructions may be defined as a recipe that is created by both the system 300 and the brewer.

For example, a first set of data may relate to the amount of extract, protein, free amino nitrogen (FAN), beta-glucan, apparent attenuation/diastatic power (AA/DP), and moisture that needs to be in each batch of product. This information may be requested in the form of the questionnaire of step 804, for example.

A second set of data may relate to the preferred color of the end product. A third set of data may relate to the flavor and/or aroma of the end product. This type of information and desired characteristics may be dependent on information such as crop year, barley variety, farm preference, or the like.

Oftentimes in recipe creation a brewer may select ingredients that are incompatible with each other. For example, 80 Beta-glucan and 100 FAN are not biologically compatible with each other. In this scenario, the system 300 may leverage data stored in the database 312 to notify the customer that this combination is not biologically possible.

Limitations in batch size are another drawback of existing techniques for following recipes to create a product. For example, malt houses may be able to only produce a product in five-ton batches at a time. This can require a single order to be split across multiple malt houses.

It should be noted, however, that the recipe is a suggestion and that conditions and operations at the time of malting could require the recipe to be adjusted to meet the customer's initial request. Once the parameters are set, the system 300 may present a list of malt houses that together are capable of meeting the customer's request. The system 300 may then allow the customer to choose the malt house(s) based on workflow parameters, while keeping the identity of the malt house(s) a secret. Or, the system 300 may select an appropriate malt house or malt houses automatically.

Step 808 involves assessing, using a processor executing instructions stored on a memory, an ability of at least one standardized piece of machinery, each piece of machinery being associated with a malt house, to fulfill at least a portion of the product order. The processor may be similar to the processor 308 of FIG. 3, for example. Accordingly, the processor may analyze the ability of at least one piece of machinery to fulfill at least a portion of the product order. The ability of the at least one standardized piece of machinery may depend on at least one of ingredients available, capacity, and delivery ability at the malt house associated with the at least one piece of machinery.

Step 810 involves assigning, using the processor, at least a portion of the product order to a first piece of machinery at a first malt house for fulfillment based on the ability of the first piece of machinery to fulfill at least the portion of the order. Accordingly, the first piece of machinery may then fulfill its portion of the order.

Step 812 is optional and involves reassigning at least the portion of the order from the first piece of machinery at the first malt house to a second piece machinery at the first malt house. If, for example, the first piece of machinery breaks down, the assigned job may be reassigned to another machine at the malt house.

Step 814 is optional and involves reassigning at least the portion of the order from the first piece of machinery at the first malt house to a second piece of machinery at a second malt house. If, for example, the first piece of machinery breaks down or the malt house unexpectedly runs out of an ingredient, the assigned job may be reassigned to another machine at a different malt house.

As another example, if a first portion of the product order was assigned to a piece of machinery at a first malt house and a second portion of the product order was assigned to a second malt house, the first portion of the order assigned to the first malt house may be reassigned to the second malt house once machinery at the second malt house becomes available. That way, the portions of the order are both fulfilled at the same malt house and may be delivered together, thereby saving on delivery costs.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

Although the previous discussions are largely directed towards fulfilling product orders in which the involved entities include brewers, malt houses, farmers, etc., other applications may benefit from the systems and methods described herein. For example, any type of business or application reliant on outside parties to provide some type of material(s), ingredient(s), service(s), product(s), or the like may benefit from the features of the embodiments described herein.

What is claimed is:

1. A method for fulfilling a product order, the method comprising:
receiving, at a network interface, a product order from a brewer;
assessing, using a processor executing instructions stored on a memory, an ability of at least one standardized piece of machinery, each piece of machinery being associated with a malt house, to fulfill at least a portion of the product order; and
assigning, using the processor, at least a portion of the product order to a first piece of machinery at a first malt house for fulfillment based on the ability of the first piece of machinery to fulfill at least the portion of the order.

2. The method of claim 1 wherein the ability of the at least one standardized piece of machinery depends on at least one of ingredients available, capacity, and delivery ability at the malt house associated with the at least one piece of machinery.

3. The method of claim 1 wherein receiving the product order from the brewer includes receiving a product specification including at least one of product ingredients, product quantity, a product recipe, product delivery location, and product delivery time.

4. The method of claim 1 further comprising presenting a questionnaire to the brewer to prompt the brewer to provide the product order.

5. The method of claim 1 further comprising reassigning at least the portion of the order from the first piece of machinery at the first malt house to a second piece of machinery at the first malt house.

6. The method of claim 1 further comprising reassigning at least the portion of the order from the first piece of machinery at the first malt house to a second piece of machinery at a second malt house.

7. The method of claim 1 further comprising:
proposing an offer for fulfillment of at least the portion of the order to at least one malt house, and
receiving an acceptance of the offer from the at least one malt house or a declination of the offer from the at least one malt house.

8. The method of claim 1 further comprising adding the brewer and the malt house to a list of authorized entities stored in a database.

9. A system for fulfilling a product order, the system comprising:
a network interface for receiving a product order from a brewer; and
a processor executing instructions stored on a memory and configured to:
assess an ability of at least one standardized piece of machinery, each piece of machinery being associated with a malt house, to fulfill at least a portion of the product order, and
assign at least a portion of the product order to a first piece of machinery at a first malt house for fulfillment based on the ability of the first piece of machinery to fulfill at least the portion of the order.

10. The system of claim 9, wherein the ability of the at least one standardized piece of machinery depends on at least one of ingredients available, capacity, and delivery ability at the malt house associated with the at least one piece of machinery.

11. The system of claim 9 wherein the product order includes a product specification including at least one of product ingredients, product quantity, a product recipe, product delivery location, and product delivery time.

12. The system of claim 9 wherein the processor is further configured to present, using a user interface, a questionnaire to the brewer to prompt the brewer to provide the product order.

13. The system of claim 9 wherein the processor is further configured to reassign at least the portion of the order from the first piece of machinery at the first malt house to a second piece of machinery at the first malt house.

14. The system of claim 9 wherein the processor is further configured to reassign at least the portion of the order from the first piece of machinery at the first malt house to a second piece of machinery at a second malt house.

15. The system of claim 9 wherein the processor is further configured to:
propose an offer for fulfillment of at least the portion of the order to at least one malt house, and
receive an acceptance of the offer from the at least one malt house or a declination of the offer from the at least one malt house.

16. The system of claim 9 wherein the processor is further configured to add the brewer and the malt house to a database including a list of authorized entities.

17. The system of claim 9 wherein an identity of the brewer is unknown to the malt house.

18. The system of claim 9 wherein an identity of the malt house that fulfills at least the portion of the order is unknown to the brewer.
